(19) United States
(12) Patent Application Publication
(10) Pub. No.: US 2026/0034492 A1
(43) Pub. Date: Feb. 5, 2026

(54) FILTER ELEMENT WITH A HANDLE ELEMENT IN A RECESS OF A FILTER MEDIUM BODY AND FILTER DEVICE WITH A FILTER ELEMENT OF THIS TYPE

(71) Applicant: MANN+HUMMEL GmbH, Ludwigsburg (DE)

(72) Inventor: Kevin KOHN, Großbottwar (DE)

(21) Appl. No.: 19/353,662

(22) Filed: Oct. 9, 2025

Related U.S. Application Data
(63) Continuation of application No. PCT/EP2024/061251, filed on Apr. 24, 2024.

(30) Foreign Application Priority Data
Apr. 24, 2023 (DE) 102023110307.5

(51) Int. Cl. B01D 46/42; B01D 45/16; B01D 46/00; B01D 46/52; B01D 50/20

(52) U.S. Cl. CPC B01D 46/4227; B01D 45/16; B01D 46/0004; B01D 46/522; B01D 50/20; B01D 2265/06; B01D 2271/027; B01D 2275/206

(57) ABSTRACT

A filter element has a filter medium body provided with an inflow side and an outflow side, wherein the filter element may be flowed through in a height direction from the inflow side to the outflow side. The filter medium body has at least one recess at the inflow side or at the outflow side and has a reduced height in the recess. A handle element is arranged in the recess and connected to the filter medium body. A circumferential seal is connected to the filter medium body at the outflow side facing away from the inflow side provided with the recess or at the inflow side facing away from the outflow side provided with the recess. The handle element spans at least a central region of the recess. A filter device has the filter element arranged in a filter housing provided with a housing pot and a housing cover.

### CROSS-REFERENCE TO RELATED APPLICATIONS

This application is a continuation application of international application No. PCT/EP2024/061251 having an international filing date of Apr. 24, 2024, and designating the United States, the international application claiming a priority date of Apr. 24, 2023, based on prior filed German patent application No. 10 2023 110 307.5, the entire contents of the aforesaid international application and of the aforesaid German patent application being incorporated herein by reference.

### BACKGROUND

The invention concerns a filter element with a filter medium body which has an inflow side and an outflow side and which may be flowed through in a height direction from the inflow side to the outflow side, wherein the filter medium body at the inflow side or outflow side has at least one recess in a region of the filter medium body having a reduced height, wherein in the recess a handle element is arranged that is connected directly or indirectly to the filter medium body.

Such a filter element is disclosed under the product number P618478 of the Donaldson Company, Inc.; compare information sheet “Product Specifications” downloaded on Mar. 21, 2023, from https://shop.donaldson.com/store/cartridges/ProductDetails-DCI/?_DARGS=/store/cartridges/ProductDetails-DCI/ProductDetails-DCI.jsp.1# This filter element includes grip eyes in rim areas of a V-shaped recess which is surrounded by a circumferential seal. A single finger may be inserted into the grip eyes, respectively.

US 2022/0088518 A1 discloses a filter element in which a seal projects past an end face of a filter medium body. Above this end face, grip pieces are provided which extend between opposed longitudinal sides of the seal.

WO 2017/192441 A1 describes a filter element with two filter bodies which are arranged in a V shape and are held by a frame. At the open side of the V-shaped filter element, stays of a first frame element of the frame extend between the two filter bodies.

Filter elements of the aforementioned type are used, for example, for filtration of combustion air for trucks or other heavy utility vehicles. Due to the size and the weight of the air filter elements, their handling upon exchange is made difficult. For separation of the raw side from the clean side, the filter element must be sealed in relation to a filter housing. In addition, in regard to the filter performance, it is desirable to utilize the available installation space as much as possible for filtration.

It is an object of the invention to provide an efficient and easily manageable filter element.

### SUMMARY

This object is solved by a filter element, for example an air filter element, with a filter medium body having an inflow side and an outflow side and configured to be flowed through in a height direction from the inflow side to the outflow side, wherein the filter medium body has at the inflow side or the outflow side at least one recess in a region of the filter medium body having a reduced height, wherein a handle element is arranged in the recess and connected indirectly or directly to the filter medium body, wherein a circumferential seal is connected to the filter medium body at an outflow side or an inflow side facing away from the inflow side or the outflow side with the recess, and wherein the handle element spans at least a central region of the recess.

This object is solved furthermore by a filter device including a filter element according to the invention and a filter housing with a housing pot and a housing cover.

Embodiments are disclosed in the following description and the accompanying drawings.

According to the invention, a filter element with a filter medium body which has an inflow side and an outflow side and may be flowed through in a height direction from the inflow side to the outflow side is provided. The filter element is for example an air filter element.

The filter medium body has at the inflow side or the outflow side at least one recess in a region of the filter medium body having a reduced height. In other words, the filter medium body is recessed in sections at one of its sides in a height direction. The recess may also be referred to as a depression. Aside from the recess, the filter element extends typically in a plane at the inflow side or the outflow side.

In the region of the recess, the filter medium body has in principle a height greater than zero. The smallest height of the filter medium body in the region of the recess amounts typically to at least 50%, for example at least 70%, of the largest height of the filter medium body adjoining the recess.

In the recess, a handle element is arranged that is connected indirectly or directly to the filter medium body. The handle element simplifies handling of the filter element, for example when it is exchanged. The handle element, for example, may be glued to the filter medium body or may be connected thereto by means of a foam, for example a polyurethane foam.

Due to the arrangement of the handle element in the recess, the required installation space of the filter element for a given filter performance (for example, in regard to a maximum volume flow and/or a maximum dust uptake capacity) is reduced. Conversely, the filter performance is increased for a defined installation space.

Further according to the invention, a circumferential seal is connected to the filter medium body at an outflow side or an inflow side which is facing away from the inflow side or the outflow side provided with the recess. In other words, the seal is arranged at the side of the filter medium body which faces away from the recess. In operation, the circumferential seal in general seals a raw side and a clean side of a filter device with the filter element. The seal may be formed of polyurethane, for example polyurethane foam. The side of the filter medium body surrounded by the seal may extend in a plane.

The invention provides furthermore that the handle element spans at least a central region of the recess. For example, the handle element may span at least a region which adjoins a center point of the recess in relation to a plane of the inflow side or the outflow side with the recess. This simplifies gripping of the handle element, for example with several fingers. In addition, the centrally arranged handle element may be designed with a certain length which further facilitates gripping by one hand. The handle element is for example spaced apart along its entire length from the filter medium body. It may then be gripped particularly comfortably and safely.

The arrangement of the seal on the side of the filter medium body which faces away from the handle element or the recess has been found to be advantageous in regard to handling and a sealing effect. For example, in this arrangement it is for example easily possible to release the seal from its seal seat at the filter housing by jiggling the handle element; this is facilitated by the possibility of gripping the handle element, which extends centrally in the recess, with several fingers, for example with the entire hand. Conversely, the seal may be inserted into its seal seat in that the filter element is moved somewhat back and forth by means of the handle element.

The central region which is spanned by the handle element adjoins in principle a central point of the recess of the inflow side or the outflow side or contains the center point. For example, the handle element may span the center point of the recess or adjoin it.

The handle element may substantially span the recess completely. For example, the handle element may span at least 70% of an expansion of the recess measured along the handle element, for example at least 85% of the expansion of the recess measured along the handle element. In this way, a particularly large handle element which may be comfortably gripped may be provided. In addition, this may simplify the fastening of the handle element at the filter medium body.

The recess may completely pass through the filter medium body in a longitudinal direction. This simplifies the manufacture of the filter medium body, for example when the filter medium body is formed with fold edges extending in longitudinal direction.

The handle element may span the recess in the longitudinal direction substantially completely, for example to at least 70%, for example to at least 85%.

In a transverse direction, regions of greatest height of the filter medium body may adjoin the recess at both sides. The regions of greatest height extend typically in a common plane. The common plane of the regions of greatest height may extend parallel to a plane of the side of the filter medium body with the seal which side faces away.

The handle element may span the recess substantially completely in the transverse direction, for example to at least 70%, for example to at least 85%.

Particularly preferred, regions of the inflow side or the outflow side with the recess project in height direction past the handle element. In other words, the handle element is completely received in the recess. In this way, a particularly compact configuration of the filter element with optimal space utilization may be obtained. The handle element does not project past the regions adjoining the recess of the inflow side or the outflow side.

An embodiment is provided wherein the filter medium body is formed with a folded filter medium and includes different fold heights. By varying the fold height, the recess may be produced particularly efficiently. In addition, it is easily possible to variably design the depth of the recess. In this way, sufficient space for gripping the handle element and the greatest possible flow-through surface area of the filter medium is provided.

As an alternative, it may be provided that the filter medium body is formed with a compact filter medium with honeycombs open at one side. In such compact filter media, the air to be filtered passes at a raw side open end into a respective honeycomb, flows through a wall of the honeycomb, whereby contaminants are retained, and exits—filtered—from a clean side open end of the neighboring honeycomb. The filter medium body may be designed for example with a plurality of media packages of different heights which are flatly glued to each other and which include open honeycombs at one side.

The handle element may be connected directly to the filter medium body. For example, the handle element may be glued to the filter medium body or may be connected thereto by means of a foam, for example a polyurethane foam.

As an alternative or in addition, the handle element may be connected by a support structure to the filter medium body. The support structure may be formed by a plastic frame and/or a grid. Preferably, the support structure is one piece together with the handle element. The handle element and the support structure may be a single injection-molded part, for example an injection-molded plastic part.

Preferably, the support structure includes at least one holding rib extending transversely to the handle element. The holding rib or one of the holding ribs may be arranged in a central region of the handle element. In this way, the handle element may be effectively stiffened. As an alternative or in addition, the holding rib or one of the holding ribs may be arranged at an end of the grip element. Handling of the filter element by means of the handle element is facilitated in this way. At the same time, a safe attachment of the handle element is achieved.

At the inflow side or at the outflow side with the recess, a further circumferential seal may be provided by means of which the handle element is connected to the filter medium body. For example, the handle element may be embedded directly or indirectly by means of a support structure in the further seal. The further seal may be formed of polyurethane, for example polyurethane foam. In operation of the filter element, the further seal typically does not contact seal-tightly a filter housing.

It may be provided that a circumferential wall, for example a cardboard wall, extends in the height direction from the inflow side to the outflow side. Such a wall ensures that the air to be filtered may enter the filter medium body only at the inflow side and exit only at the outflow side from the filter medium body.

The wall may be embedded in the seal and the further seal. The further seal participates thus on the one hand in fluid guiding. On the other hand, the further seal serves to attach the handle element to the filter medium body.

The scope of the present invention also encompasses a filter device including an above-described filter element according to the invention and a filter housing with a housing pot and a housing cover. The filter element may be arranged in the filter housing for operating the filter device.

Preferably, the housing cover includes a projection for contacting the handle element. The filter element and the housing cover may be aligned relative to each other and/or supported at each other in this way.

The projection and the handle element may be matched to each other in such a way that the projection contacting the handle element effects an alignment of the housing cover transversely to the height direction relative to the filter element. In this manner, a pre-centering action of the housing cover during assembly may be achieved. For example, closing of the housing cover is facilitated in this way. In addition, the filter element is supported in the completely assembled state transversely to the height direction at the projection of the housing cover so that vibrations of the filter element are reduced.

As an alternative or in addition, it may be provided that in the assembled state the projection fixes the filter element in height direction, for example wherein the filter element is clamped between the projection of the housing cover and the housing pot. In this way, the seal may be pressed against the housing pot. When the cover is closed, a sealing action of the raw side in relation to the clean side is thus reliably ensured.

The filter device may furthermore include a cyclone block which projects into the recess. The cyclone block enables a pre-filtration. The recess in this embodiment is arranged in principle at the inflow side. The cyclone block as well as the handle element are at least partially received in the recess so that a particularly space-saving filter device is obtained.

### BRIEF DESCRIPTION OF THE DRAWINGS

Further features and advantages of the invention result from the following detailed description of embodiments of the invention based on the drawing figures showing details according to the invention. The aforementioned and still to be explained features may be realized individually by themselves or several combined in any expedient combinations in variants of the invention. The features illustrated in the drawings are illustrated such that the particularities according to the invention may be made clearly visible.

FIG. 1 shows a first embodiment of a filter element according to the invention with a filter medium body of zigzag-shaped folded filter medium, which comprises a V-shaped recess continuous in the direction of fold edges in which a handle element is arranged, in a schematic perspective view.

FIG. 2 shows the filter element of FIG. 1 in a schematic cross section view.

FIG. 3 shows a filter device according to the invention with the filter element of FIG. 1 in a schematic section illustration.

FIG. 4 shows a second embodiment of a filter element according to the invention with a ribbed filter medium in a schematic perspective view.

FIG. 5 shows a third embodiment of a filter element according to the invention with a filter medium body of zigzag-shaped folded filter medium, which comprises a stepped recess in which a handle element is arranged, in a schematic perspective view.

FIG. 6 shows a filter device according to the invention with a filter element of FIG. 5 in a schematic longitudinal section.

FIG. 7 shows the filter device of FIG. 6 in a schematic cross section view.

FIG. 8 shows a fourth embodiment of a filter element according to the invention of three media packages which are glued together flatly in a schematic cross section view.

### DETAILED DESCRIPTION

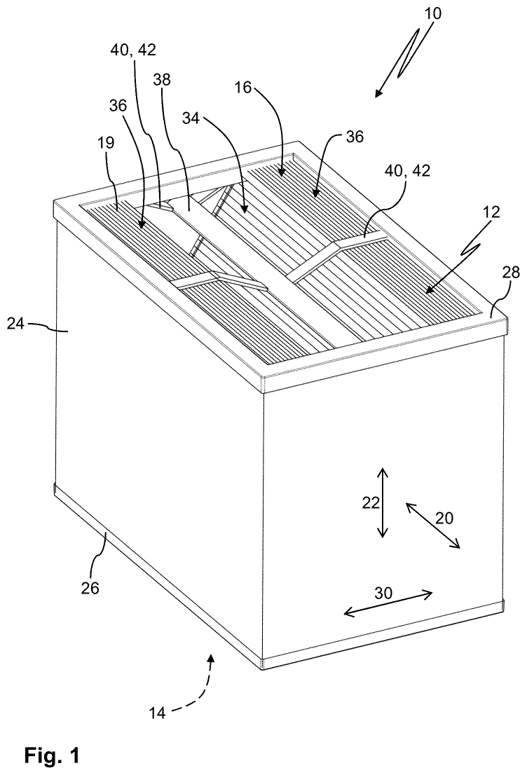

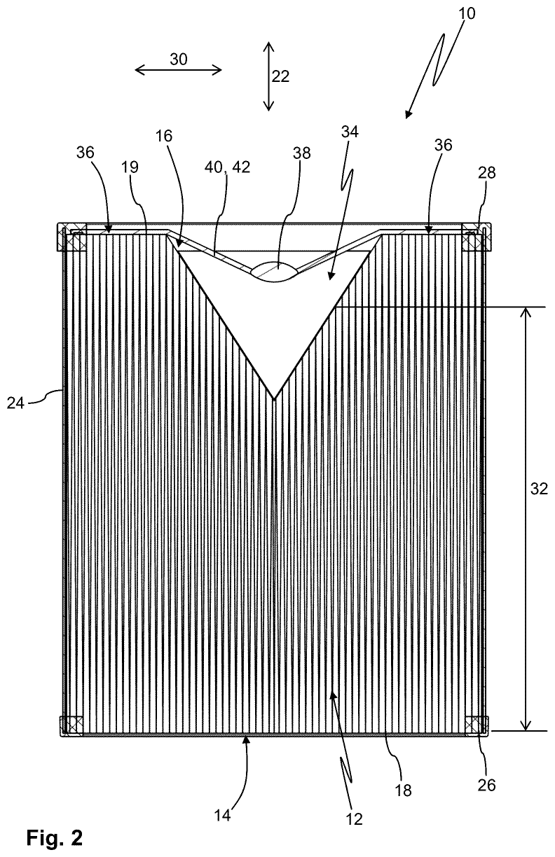

FIG. 1 shows a filter element 10 embodied as an air filter element. The filter element 10 comprises a filter medium body 12 which here is comprised of zigzag-shaped folded filter paper. An inflow side 14 and an outflow side 16 are defined by fold edges 18, 19, respectively; compare also FIG. 2. The fold edges 18, 19 extend along a longitudinal direction 20 (compare FIG. 1; in FIG. 2, the longitudinal direction extends perpendicularly to the drawing plane). The filter medium body 12 may be flowed through in a height direction 22 from the inflow side 14 to the outflow side 16. An outer circumference of the filter medium body 12 is sealed by a wall 24 which may be comprised of cardboard. At the inflow side 14, the filter medium body 12 is framed by a circumferential seal 26. At the outflow side 16, the filter medium body 12 is framed by a further circumferential seal 28. The seals 26, 28 connect the wall 24 to the filter medium body 12.

In a transverse direction 30, the fold heights 32 of the filter medium body 12 vary so that the latter—here, for example, at the outflow side 16—comprises a recess 34. As may be seen for example in FIG. 1, the recess 34 is continuously configured along the fold edges 18, 19 in the longitudinal direction 20. At both sides of the recess 34, regions 36 of greatest height extend in a common plane in the transverse direction 30 at the outflow side 16. In the region of the recess 34, the filter medium body 12 comprises in comparison thereto a reduced (fold) height 32, compare for example FIG. 2. The inflow side fold edges 18 extend as a whole in a common plane which extends parallel to the plane of the outflow side regions 36 of greatest height, compare for example FIG. 2. In another embodiment which is not illustrated, the inflow side fold edges 18 as a whole may extend in a common plane which extends at a slant angle relative to the plane of the outflow side regions 36 of greatest height.

The filter element 10 comprises a handle element 38 which is received completely in the recess 34. The handle element 38 spans a central region of the recess 34, wherein it extends spaced apart from the outflow side fold edges 19. In the illustrated embodiment, the handle element 38 extends in a longitudinal center plane parallel to the fold edges 18, 19. In the illustrated embodiment, the handle element 38 extends completely through the recess 34 in the longitudinal direction 20. The regions 36 of greatest height project in the height direction 22 past the handle element 38. The handle element 38 comprises here an oval cross section, compare FIG. 2.

A support structure 40 is formed as one piece together with the handle element 38. The support structure 40 comprises three holding ribs 42 extending transversely to the handle element 38. The holding ribs 42 of the support structure 40 are embedded each in the further seal 28 so that the handle element 38 is fastened non-releasably at the filter medium body 12. Two of the holding ribs 42 are arranged at the ends at the handle element 38. One of the holding ribs 42 is located at the center of the handle element 38.

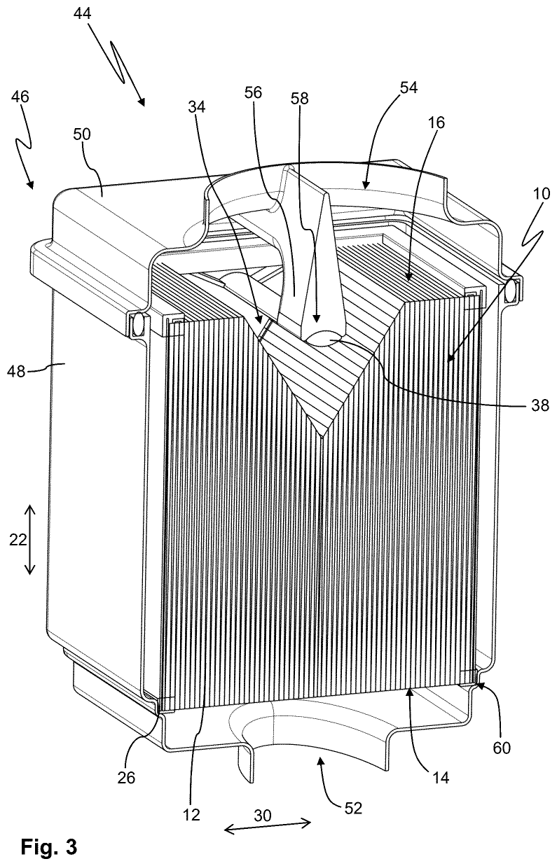

FIG. 3 shows a filter device 44 with the filter element 10. The filter element 10 is arranged in a filter housing 46 which is comprised of a housing pot 48 and a housing cover 50. A raw air inlet 52 is formed here in the housing pot 48; a clean air outlet 54 is formed here in the housing cover 50. Air to be filtered is guided via the raw air inlet 52 to the inflow side 14. The filtered air is discharged from the outflow side 16 through the clean air outlet 54.

It should be noted that the flow through the filter medium body 12 and the filter housing 46 may also be realized in reverse direction: the recess 34 would then be arranged at the inflow side. Raw air inlet and clean air outlet as well as inflow side and outflow side would be correspondingly switched in this case (not illustrated in detail).

At the housing cover 50, a projection 56 is formed which presently projects in the region of the clean air outlet 54 inwardly into the filter housing 46. In the mounted state, the projection 56 is supported at the handle element 38.

A free end 58 of the projection 56 is recessed in accordance with the oval cross section of the handle element 38. In the transverse direction 30, a form fit is thus provided between the projection 56 and the handle element 38; the filter element 10 is aligned in the transverse direction 30 by means of the projection 56 at the housing cover 50. In this way, for example a contact of the further seal 28 with the filter housing 46 may be avoided.

In the height direction 22, the projection 56 is dimensioned such that the seal 26 facing away from the recess 34 is pressed against the seal seat 60 in the housing pot 48. The occurrence of a leakage flow past the filter element 10 is thus reliably prevented.

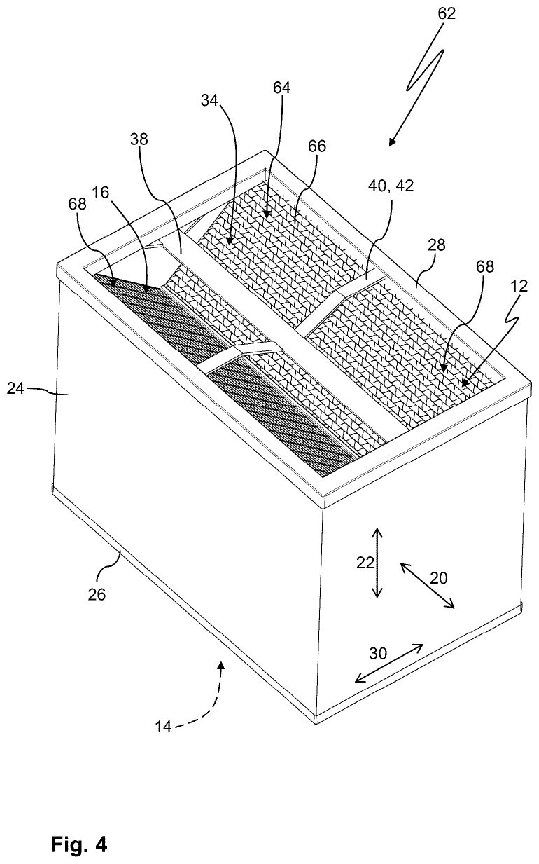

FIG. 4 shows a filter element 62 which, in important aspects, corresponds to the previously described filter element 10, compare FIGS. 1 to 3. In the following, primarily the differences are illustrated. In other respects, reference is being had to the above description.

In the filter element 62 a filter medium body 12 is formed with a compact filter medium 64. The compact filter medium 64 comprises honeycombs 66 which extend in height direction 22. In a manner not illustrated in detail, the honeycombs 66 are closed at the inflow side 14 or at the outflow side 16, respectively, wherein neighboring honeycombs 66 are open or closed at opposite sides. Air to be filtered enters thus one of the honeycombs 66 at one end and, after passing through the compact filter medium 64 delimiting the honeycombs, exits from a neighboring honeycomb 66 at the other end.

In the filter element 62, the entire outflow side 16 is recessed in a V-shape so that a recess 34 is formed as a V-shaped depression. The filter medium body 12 may be formed by two media packages 68 which are glued to each other in the longitudinal center plane. Lateral rims of the media packages 68 or of the filter medium body 12 project in height direction past the handle element 38 received in the recess.

The filter element 62 may be used in the filter housing 46 like the filter element 10.

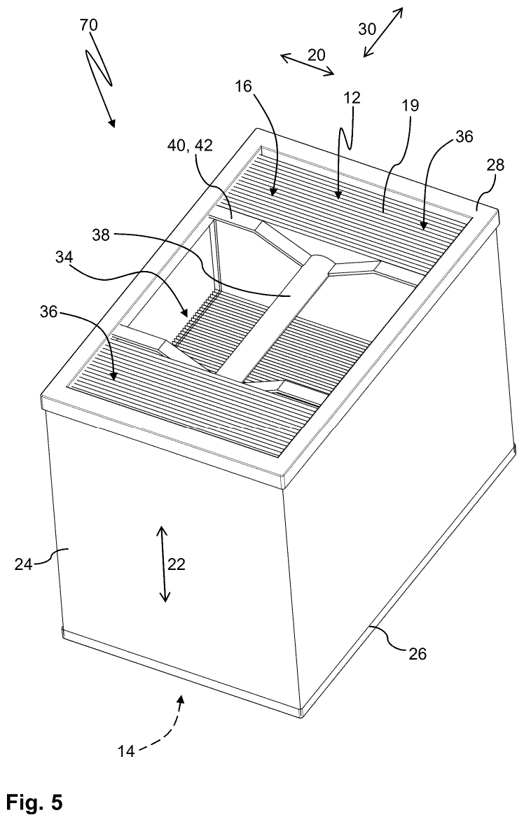

FIG. 5 shows a filter element 70 whose filter medium body 12 is comprised of folded filter paper. In regard to structure and function of the filter element 70, reference is therefore being had to the previous description of the filter element 10. In the following, primarily the differences will be explained.

A recess 34 is arranged at the outflow side 16 comprises a rectangular cross section. In other words, the filter medium body 12 of the filter element 70 is recessed at its outflow side 16 in a stepped manner. The recess 34 extends in the longitudinal direction 20 along fold edges 19 through the filter medium body 12. In the transverse direction 30, regions 36 of greatest height are formed at both sides of the recess 34.

A handle element 38 extends here in the transverse direction 30 across the entire width of the recess 34. The handle element 38 in height direction is arranged below the raised regions (regions 36 of greatest height) of the outflow side 16. For attachment of the handle element 38, two holding ribs 42 of a support structure 40 are provided at the ends and as one piece therewith which engage an outflow side seal 28.

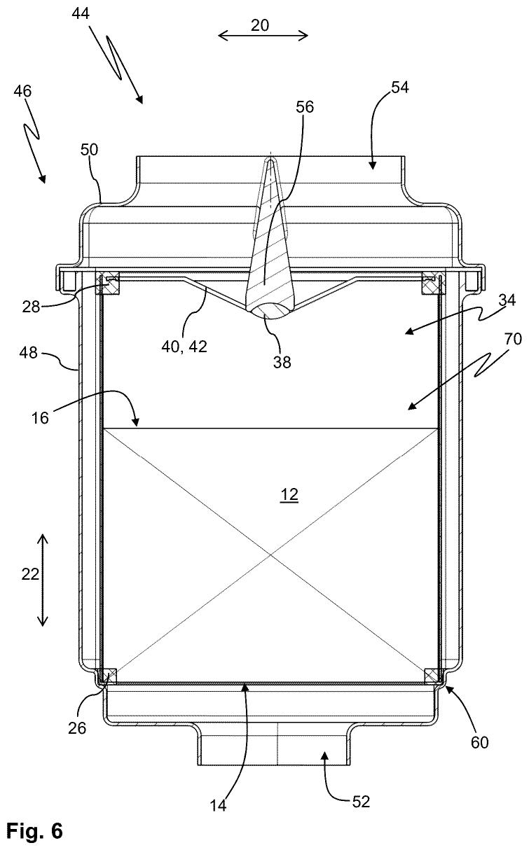

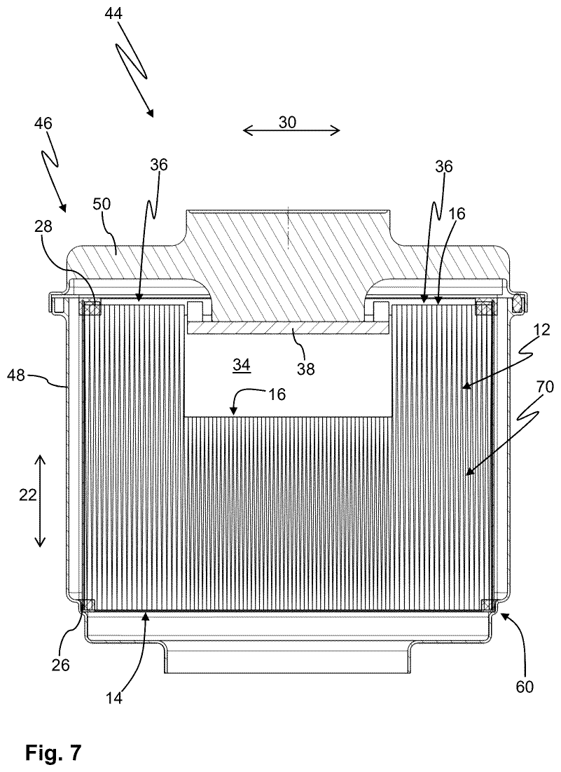

In FIGS. 6 and 7, it may be seen that the filter element 70—similar to the filter element 10—may be received in a filter housing 46 comprising a housing pot 48 and a housing cover 50. For alignment and fixation of the filter element 70 in the filter housing 46, a projection 56 is supported at the handle element 38, wherein the projection 56 and the handle element 38 are shaped so as to correspond in the contact region. The filter element 70 is thus supported here in the longitudinal direction 20 by means of the projection 56 with form fit at the housing cover 50, compare FIG. 6. The projection 56 pushes the filter element 70 (as in the case of the filter element 10) in the height direction 22 into a seal seat 60 of the housing pot 48.

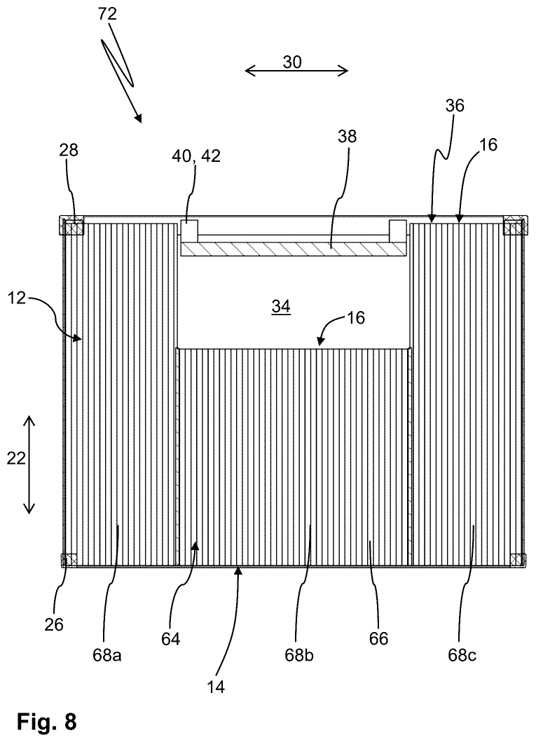

FIG. 8 shows a filter element 72 which corresponds in its shape to the filter element 70 (compare FIG. 5) and may be used like the latter in a filter device 44. In this respect, reference is being had to the previous description and the FIGS. 6 and 7.

In the filter element 72—as in the filter element 62 (compare FIG. 4 and the corresponding description)—a filter medium body 12 is formed with a compact filter medium 64. Presently, three media packages 68a, 68b, 68c are glued together, wherein the two outer media packages 68a, 68c in the transverse direction 30 comprise a greater height than the central media package 68b. In the region of the central media package 68b, a recess 34, which is completely bridged by a handle element 38, is thus formed at the outflow side 16. In this context, the handle element 38 is arranged below regions 36 of greatest height which are formed at the two media packages 68a, 68c.

In summary, the invention concerns a filter element with a filter medium body which at a side to be flowed through comprises a depression so that a recess is formed. A handle element is arranged in the depression or recess and extends across a central region of the depression or recess. For example, the handle element may pass completely through the depression or recess. At a side which is oppositely positioned to the depression or recess, the filter element comprises a circumferential seal. When using the filter element, the circumferential seal contacts a first housing part of a filter housing in a seal-tight manner. The filter element may be supported by the handle element at a second housing part of the filter housing.

### REFERENCE CHARACTERS

filter element 10; 62; 70; 72
filter medium body 12
inflow side 14
outflow side 16
fold edges 18, 19
longitudinal direction 20
height direction 22
wall 24
seal 26
further (circumferential) seal 28
transverse direction 30
fold heights 32
recess 34
regions 36 of greatest (fold) height
handle element 38
support structure 40
holding ribs 42
filter device 44
filter housing 46
housing pot 48
housing cover 50
raw air inlet 52
clean air outlet 54
projection 56
free end 58
seal seat 60
compact filter medium 64
honeycombs 66
media packages 68; 68a, 68b, 68c

What is claimed is:

1. A filter element comprising:
a filter medium body comprising an inflow side and an outflow side and configured to be flowed through in a height direction from the inflow side to the outflow side;
wherein the filter medium body comprises at least one recess provided at the inflow side or provided at the outflow side, wherein the filter medium body comprises a reduced height in the at least one recess in the height direction;
a handle element arranged in the at least one recess and connected to the filter medium body;
a first circumferential seal connected to the filter medium body at the outflow side facing away from the inflow side provided with the at least one recess or at the inflow side facing away from the outflow side provided with the at least one recess;
wherein the handle element spans at least a central region of the at least one recess.

2. The filter element according to claim 1, wherein the handle element spans an expansion of the at least one recess completely.

3. The filter element according to claim 1, wherein the handle element spans at least 70% of an expansion of the at least one recess measured along the handle element.

4. The filter element according to claim 3, wherein the handle element spans at least 85% of the expansion of the at least one recess measured along the handle element.

5. The filter element according to claim 1, wherein the at least one recess extends completely across the filter medium body in a longitudinal direction.

6. The filter element according to claim 1, wherein the filter medium body comprises regions of greatest height in the height direction, wherein the regions of greatest height adjoin the at least one recess on opposed sides of the at least one recess in a transverse direction.

7. The filter element according to claim 1, wherein regions of the inflow side provided with the at least one recess or regions of the outflow side provided with the at least one recess project past the handle element in the height direction.

8. The filter element according to claim 1, wherein the filter medium body is comprised of a folded filter medium and comprises different fold heights.

9. The filter element according to claim 1, wherein the filter medium body is comprised of a compact filter medium with honeycombs open at one side.

10. The filter element according to claim 1, further comprising a support structure, wherein the handle element is connected by the support structure to the filter medium body.

11. The filter element according to claim 10, wherein the support structure comprises a holding rib extending transversely to the handle element.

12. The filter element according to claim 1, further comprising a second circumferential seal arranged at the inflow side provided with the at least one recess or arranged at the outflow side provided with the at least one recess, wherein the handle element is connected to the filter medium body by the second circumferential seal.

13. The filter element according to claim 1, further comprising a circumferential wall extending in the height direction from the inflow side to the outflow side.

14. The filter element according to claim 13, wherein the circumferential wall extending in the height direction is a cardboard wall.

15. A filter device comprising:
a filter element according to claim 1; and
a filter housing comprising a housing pot and a housing cover, wherein the filter element is configured to be arranged in the filter housing.

16. The filter device according to claim 15, wherein the housing cover comprises a projection configured to contact the handle element of the filter element.

17. The filter device according to claim 16, wherein the projection of the housing cover, when contacting the handle element, effects an alignment of the housing cover relative to the filter element transverse to the height direction of the filter element.

18. The filter device according to claim 16, wherein, in an assembled state of the filter device, the projection of the housing cover fixes the filter element in the height direction of the filter element.

19. The filter device according to claim 18, wherein, in the assembled state of the filter device, the filter element is clamped between the projection of the housing cover and the housing pot.

20. The filter device according to claim 15, further comprising a cyclone block which projects into the at least one recess at the inflow side or at the outflow side of the filter element.
